(19) United States
(12) Patent Application Publication
(10) Pub. No.: US 2013/0075996 A1
(43) Pub. Date: Mar. 28, 2013

(54) TRICYCLE

(71) Applicant: Matthew F. ARMBRUSTER, Lafayette, CO (US)

(72) Inventor: Matthew F. ARMBRUSTER, Lafayette, CO (US)

(21) Appl. No.: 13/625,674

(22) Filed: Sep. 24, 2012

Related U.S. Application Data
(60) Provisional application No. 61/538,571, filed on Sep. 23, 2011.

(51) Int. Cl. B62M 1/06

(52) U.S. Cl. 280/259

(57) ABSTRACT

Adult-sized tricycles may include a large front wheel, a downward-sloping frame, and a riding position in which the lower legs of a rider approximate a head tube angle.

### CROSS-REFERENCE TO RELATED APPLICATION

This application claims priority to U.S. Provisional Patent Application Ser. No. 61/538,571, filed Sep. 23, 2011, which is hereby incorporated by reference.

### BACKGROUND

Tricycles are three-wheeled human-powered vehicles. A big wheel tricycle is an example of a tricycle that includes two rear wheels and a single front wheel larger than the rear wheels. Many people remember the thrill of riding a big wheel tricycle during their pre-school years and would be interested in reliving those years in an adult version of the big wheel tricycle.

### SUMMARY

In some examples, a three-wheeled, human-powered vehicle may include a frame including a frame tube having a first end and a second end, a head tube attached to the frame tube at the first end, and an axle tube attached to the frame tube at the second end. A fork may be pivotably attached to the head tube. A front wheel having a hub may be rotatably attached to the fork. A pair of crank shafts may be attached to the hub of the front wheel, each crank shaft including a foot pedal. First and second rear wheels may be rotatably connected proximate opposite ends of the axle tube. A seat may be attached to the frame tube proximate the second end of the frame tube. A head tube angle may be defined as an acute angle formed by a longitudinal axis of the head tube with respect to a substantially planar support surface when the front wheel and rear wheels are in contact with the support surface. Lower legs of a rider supported by the seat and having a foot disposed on each of a respective one of the two foot pedals will form a lower leg angle with respect to the support surface, and the lower leg angle may approximate the head tube angle.

In some examples, a three-wheeled human-powered vehicle may include a frame including a frame tube having a first end and a second end, a head tube having a first longitudinal axis and connected to the first end of the frame tube, and an axle tube operatively connected to the second end of the frame tube. A fork assembly may be rotatably connected to the head tube. A front wheel may be rotatably connected to the fork assembly. A first rear wheel and a second rear wheel may be rotatably connected to the axle tube on respective opposite sides of a midpoint of the axle tube. A seat may be adjustably connected to a substantially linear inclined portion of the frame tube proximate the second end of the frame tube. The substantially linear inclined portion of the frame tube may have a second longitudinal axis. A downward-opening obtuse angle may be formed between a first line including the first longitudinal axis and a second line including the second longitudinal axis, and the obtuse angle may be greater than about 120 degrees.

In some examples, a three-wheeled human-powered vehicle may include a frame including a frame tube having a first end and a second end, a head tube connected to the first end of the frame tube, and an axle tube operatively connected to the second end of the frame tube. A fork assembly may be connected to the head tube such that the fork assembly is rotatable about a longitudinal axis of the head tube. A front wheel may be rotatably connected to the fork assembly. A first rear wheel and a second rear wheel may be rotatably connected to the axle tube on respective opposite sides of a midpoint of the axle tube. A seat may be adjustably connected to a substantially linear portion of the frame tube proximate the second end of the frame tube, the substantially linear portion of the frame tube having a longitudinal axis. A head tube angle may be defined as an acute angle formed by the longitudinal axis of the head tube with respect to a substantially planar support surface when the front wheel and rear wheels are in contact with the support surface. A seat support angle may be formed between the substantially planar support surface and the longitudinal axis of the substantially linear portion of the frame tube. For example, the head tube angle may be approximately 45 degrees or less, and the seat support angle may be approximately 18 degrees, but generally is expected to fall into the range of approximately 25 degrees or less.

In some examples, a three-wheeled human-powered vehicle may include a frame including a frame tube having a first end and a second end, a head tube connected to the first end of the frame tube, and an axle tube operatively connected to the second end of the frame tube. A fork assembly may be connected to the head tube such that the fork assembly is rotatable about a longitudinal axis of the head tube, the fork assembly being angled from the first end of the frame tube away from the second end of the frame tube. A front wheel may be rotatably connected to the fork assembly. A first and a second crank arm for imparting rotational motion to the front wheel may be operatively connected to respective opposite sides of a hub of the front wheel. A handlebar may be operatively connected to the fork assembly for rotating the fork assembly about the longitudinal axis of the head tube. A first rear wheel and a second rear wheel may be rotatably connected to the axle tube on respective opposite sides of a midpoint of the axle tube. Rotating the fork assembly when the front and rear wheels are supported on a support surface may cause the front wheel simultaneously to tilt about an axis substantially parallel to the support surface and to rotate about an axis substantially perpendicular to the support surface.

### BRIEF DESCRIPTION OF DRAWINGS

FIG. 1 shows a front perspective view of an illustrative tricycle.

FIG. 2 shows a rear perspective view of the tricycle of FIG. 1.

FIG. 3 shows a side elevation view of an illustrative tricycle indicating two possible seat positions.

FIG. 4 shows a side elevation view of an illustrative tricycle showing leg positions of a rider.

FIG. 5 shows a perspective view of an illustrative tricycle showing leg positions of a rider with handlebars turned.

FIGS. 6A-6C show side elevation, plan, and front elevation views of an illustrative wheel having a vertical fork.

FIGS. 7A-7C show side elevation, plan, and front elevation views of an illustrative wheel having a horizontal fork.

FIGS. 8A-8C show side elevation, plan, and front elevation views of an illustrative wheel having an angled fork.

### DETAILED DESCRIPTION

The present disclosure provides a tricycle having a large front wheel and an angled head tube. In some embodiments, a tricycle includes a low, angled seat and rear wheels having a low coefficient of friction relative to the front wheel. Many alternatives and modifications which may or may not be expressly mentioned are enabled, implied, and accordingly covered by the spirit of the disclosure.

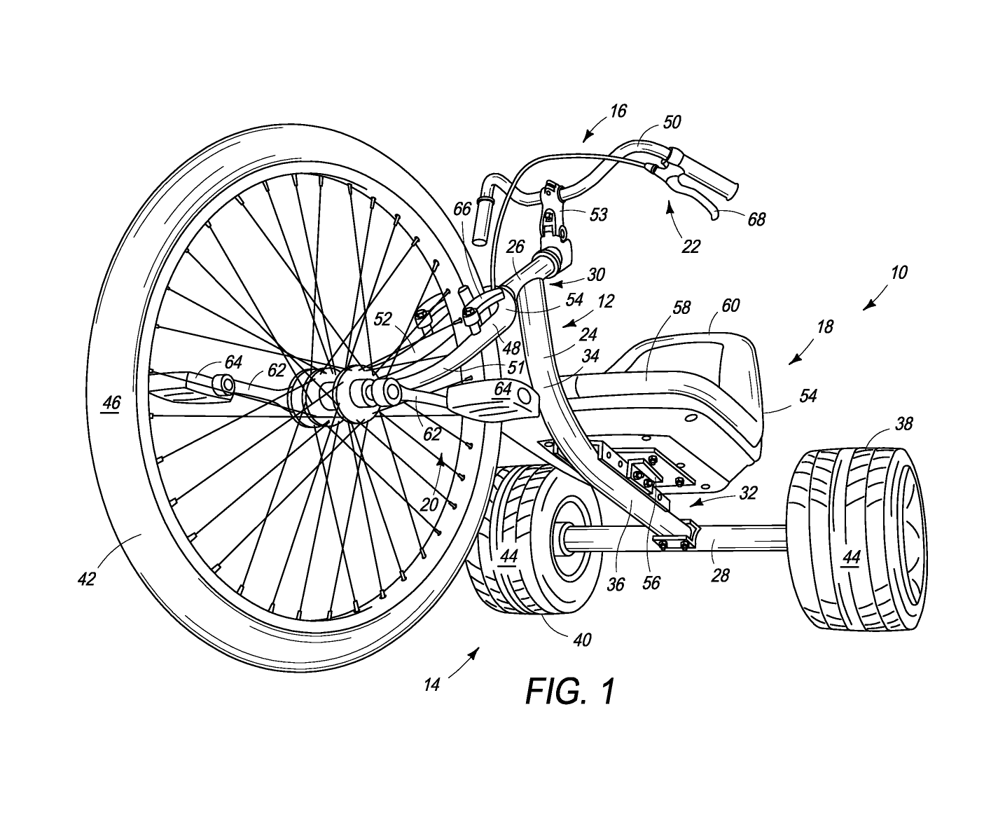

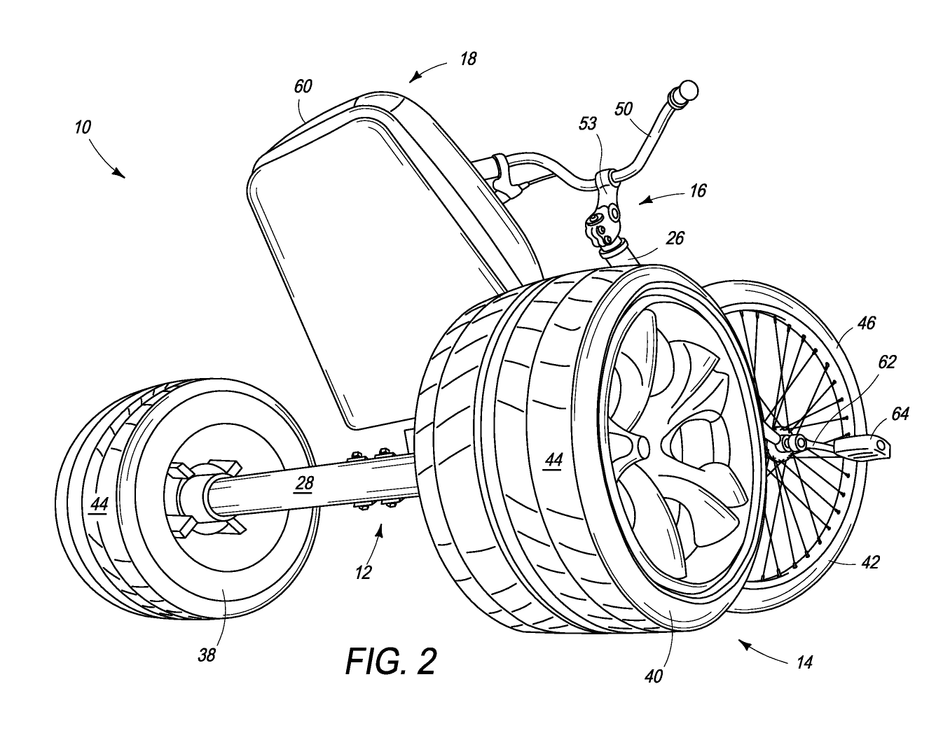

Turning to FIGS. 1 and 2, an illustrative tricycle is generally indicated at 10. In this example, tricycle 10 includes a frame assembly 12, a wheel assembly 14, a steering assembly 16, a seat assembly 18, a drive assembly 20, and a braking assembly 22.

Frame assembly 12 may be any suitable structure configured to provide a supportive framework for mounting other components on tricycle 10 as described below. Frame assembly 12 may include one or more frame members such as frame tube 24, a head tube 26, and an axle tube 28. Frame tube 24 may be any suitable structure configured to provide a substantially rigid, longitudinal support for spacing head tube 26 from axle tube 28. In some examples, frame assembly 12 may include multiple frame tubes. For example, two substantially parallel frame tubes may be provided. In other examples, two frame tubes may be mounted in a vertical or horizontal V configuration, with the vertex of the V connected to head tube 26 and the legs of the V disposed either side by side or one over the other. Frame tube 24 may also provide a support surface for mounting seat assembly 18.

Frame tube 24 may have a first end 30 and a second end 32 opposite first end 30. In the example shown in FIGS. 1 and 2, head tube 26 is rigidly connected to first end 30 of frame tube 24. Head tube 26 may be connected to frame tube 24 by any method known in the art, such as by welding, bolting, or using brazed lugs. Frame tube 24 may be any suitable shape configured to orient head tube 26 at a desired angle at first end 30 with second end 32 generally disposed at a lower elevation than first end 30. This downward sloping frame configuration ensures that a seat mounting support surface and axle tube 28 will be disposed below the elevation of head tube 26. In the example shown in FIGS. 1 and 2, frame tube 24 includes a curved portion 34, and a linear or substantially linear inclined portion 36. In this example, frame tube 24 slopes continuously downward from first end 30 to second end 32. In other examples, one or more portions of frame tube 24 may be horizontal or even upward-sloping.

Head tube 26 may be any suitable structure configured to pivotably support a steering fork for a front wheel of tricycle 10. Head tube 26 may be a typical head tube found in bicycles and tricycles known in the art. As discussed above, head tube 26 may be rigidly affixed to first end 30 of frame tube 24.

Axle tube 28 may be any suitable structure configured to provide spaced support for mounting one or more rear wheels of the tricycle. In the example shown in FIGS. 1 and 2, axle tube 28 is a continuous length of substantially rigid tube mounted crosswise to second end 32 of frame tube 24 substantially at a midpoint of the axle tube. In some examples, axle tube 28 may include two portions each mounted to one respective side of a frame tube. In other examples, axle tube 28 may be mounted to frame tube 24 at a position spaced from second end 32. Axle tube 28 may be mounted to frame tube 24 by any known method, such as using a bolted flange assembly, by welding, or by brazing. In the example shown in FIGS. 1 and 2, a flange assembly is used.

Wheel assembly 14 may be any suitable assembly configured to provide rolling or sliding support for tricycle 10 and to facilitate movement of tricycle 10 across a support surface. For example, wheel assembly 14 may include two rear wheels 38 and 40 and a front wheel 42. In some examples, rear wheels 38 and 40 may be rotatably attached to opposite ends of axle tube 28. In other examples, rear wheels 38 and 40 may be configured as steerable wheels such that each wheel is capable of rotating and pivoting side to side. In some examples, rear wheels 38 and 40 each include an outer surface 44 that may have a tread pattern or textured profile. In other examples, outer surface 44 may be substantially smooth. Rear wheels 38 and 40 may include materials with a low coefficient of friction relative to front wheel 42. For example, rear wheels 38 and 40 may include a material such as ABS plastic making up a substantial portion of outer surface 44. Rear wheels 38 and 40 may include molded thermoplastics.

In the example shown in FIGS. 1 and 2, front wheel 42 is a relatively large, central hub, spoked wheel having a pneumatic or semi-pneumatic outer tire 46. Tire 46 may include a tread. Front wheel 42 may be significantly larger than rear wheels 38 and 40, and may be about 24 to about 29 inches in diameter. In some examples, front wheel 42 is steerable and is configured as a drive wheel for tricycle 10. Accordingly, front wheel 42 may be operatively connected to both steering assembly 16 and drive assembly 20.

Steering assembly 16 may be any suitable assembly configured to provide an interface for a user to turn tricycle 10. In the example shown in FIGS. 1 and 2, steering assembly 16 may include a fork 48 and a steering bar or handlebar 50. Fork 48 may be any suitable structure configured to pivotably mount to head tube 26 and to provide a rotatable attachment for front wheel 42. For example, fork 48 may be a forked structure having two fork blades 51 and 52 joined at a crown 54 and having a steering portion that inserts into head tube 26 and provides a mounting surface for handlebar 50. In some examples, fork 48 may include a suspension feature, such as a shock absorber. Fork blades 51 and 52 may straddle front wheel 42, and may be raked or straight. In some examples, fork blades 51 and 52 may connect to a hub of front wheel 42 using drop-out connectors such as a typical 9 mm drop-out. In other examples, fork blades 51 and 52 may include axle holes for mounting an axle of front wheel 42, such as in a 15QR fork. Many other mechanisms may be used to connect the fork blades to the hub, such as unicycle-style hub clamps.

Handlebar 50 may be any suitable structure configured to provide an interface for a user to manually steer tricycle 10. For example, handlebar 50 may be a two-handed rising handlebar as shown in FIGS. 1 and 2. Other styles of handlebar may be suitable, including straight, upright, BMX, cruiser, moustache, and/or ape hangers. Handlebar 50 may be connected to fork 48 either directly or using a stem 53. Fork 48 may be placeable in a plurality of rotational positions by manipulating handlebar 50.

Seat assembly 18 may be any suitable assembly configured to provide and attach a seat to frame assembly 12. In the example shown in FIGS. 1 and 2, seat assembly 18 includes a seat 54 and a coupler 56. Seat 54 may be any suitable seat configured to provide a support surface for one or more human riders. In some examples, seat 54 may include a chair-type seat having a seat portion 58 and a back support portion 60. In other examples, seat 54 may include a bicycle saddle. Coupler 56 may be any suitable structure configured to securely mount seat 54 to frame assembly 12. For example, coupler 56 may be a clamping structure configured to clamp to inclined portion 36 of frame tube 24.

Coupler 56 may facilitate an adjustable seat position, in which case seat assembly 18 may be configured to allow a rider to adjust the seat relative to the steering assembly and/or head tube, thereby allowing riders of various sizes to use tricycle 10. In some examples, adjustability may be facilitated by providing multiple bolt holes in a mounting surface along a length of inclined portion 36, such that coupler 56 may be bolted to frame tube 24 in any one of a plurality of selectable discrete positions. In other examples, adjustability may be facilitated by providing a sliding rail-and-trolley assembly such that seat 54 remains slidingly connected to frame tube 24. In these examples, seat position may be either continuously or discretely selectable.

Drive assembly 20 may include any suitable structure configured to allow a rider to rotate one or more wheels of wheel assembly 14. In some examples such as the one shown in FIGS. 1 and 2, drive assembly 20 may include a pair of crank arms such as crankshafts 62 connected to the hub of the front wheel, each crankshaft 62 including a pedal 64 to facilitate rotation of the crankshafts by the feet of a rider. This may be referred to as a “direct drive” configuration. In other examples, pedals 64 may be connected to the front and/or rear wheels via a chain assembly and/or a gear assembly, which may be referred to as a “chain drive” or “gear-drive” configuration.

In some examples, tricycle 10 may include a braking assembly 22. Braking assembly 22 may be any suitable assembly configured to selectively slow or stop the tricycle. For example, braking assembly 22 may include a brake 66 and an actuator 68.

Brake 66 may be any suitable brake. For example, brake 66 may be a hydraulic or mechanical side- or center-pull caliper brake configured to slow front wheel 42 using a frictional interface between brake pads and a rim of front wheel 42. In other examples, brake 66 may include a disc brake. In other examples, brake 66 may include a drum brake or a coaster brake. Actuator 68 may be any suitable brake actuator or handle configured to provide a rider-controlled trigger for brake 66. For example, actuator 68 may include a handlebar-mounted brake lever, operatively connected to brake 66. In other examples, brake 66 and actuator 68 may include a hand-operated friction brake for slowing or stopping one or more of the rear wheels.

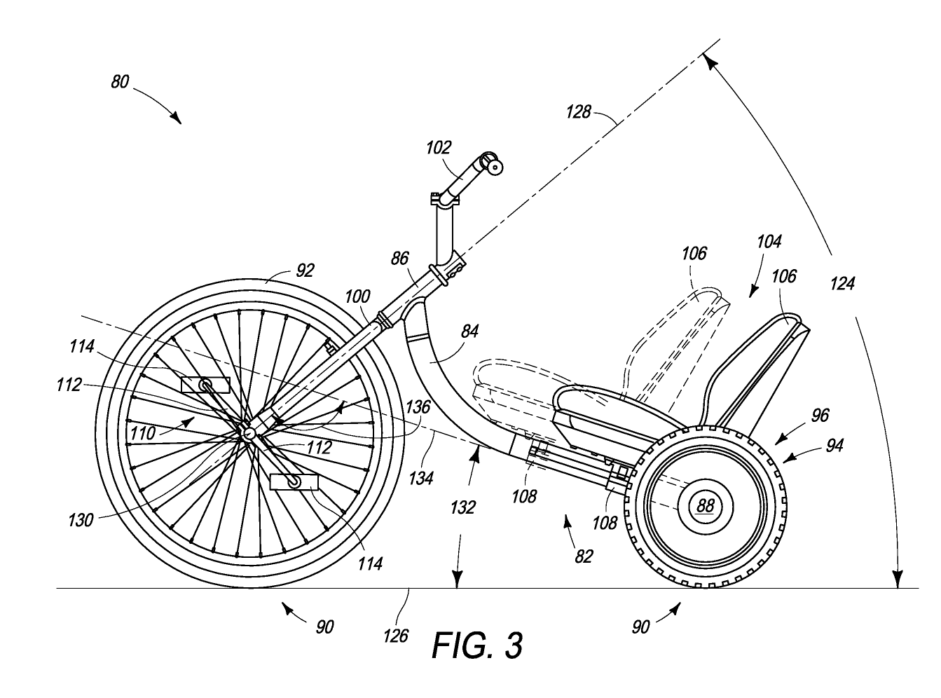

FIG. 3 depicts an illustrative tricycle 80 similar to tricycle 10. Corresponding to the various assemblies of tricycle 10, tricycle 80 includes a frame assembly 82 (including a frame tube 84, head tube 86, and axle tube 88), a wheel assembly 90 (including a front wheel 92, and two rear wheels 94 and 96), a steering assembly 98 (including a fork 100 and a handlebar 102), a seat assembly 104 (including a seat 106 and a coupler 108), and a drive assembly 110 (including crank shafts 112 and pedals 114). Frame assembly 82 includes portions corresponding to the portions of frame assembly 12 described above, namely a first end 116, a second end 118, a curvilinear or curved portion 120, and a substantially linear inclined portion 122.

Head tube 86 is connected to first end 116 of frame tube 84 with an orientation that creates a head tube angle 124 with respect to a substantially planar support surface 126. As used here, head tube angle 124 is defined as the acute angle formed between a longitudinal axis 128 of head tube 124 and support surface 126 when the front wheel 92 and rear wheels 94 and 96 are in contact with the support surface. Head tube angle 124 may be any suitable acute angle configured to approximate the angle of a rider's lower legs when the rider's feet are in contact with pedals 114. For example, head tube angle 124 may be approximately 35-45 degrees, and preferably approximately 40 degrees, causing a hub 130 of wheel 92 to be positioned significantly forward of the head tube. This angle is quite different from typical tricycles and bicycles, which can be in a range of 65 to 80 degrees. In this example, tricycle 80 includes a straight fork 100. It is also noted that fork 100 may be raked forward as shown in FIGS. 1 and 2, altering further the effect head tube angle 124 has on the relative position of hub 130. The shallow head tube angle 124 has a marked effect on rider safety and comfort, along with other dimensions of tricycle 80, as discussed further below.

A seat support angle 132 may be defined as the acute angle formed between a longitudinal axis 134 of inclined portion 122 of frame tube 84 and support surface 126 when wheels 92, 94, and 96 are in contact with the support surface. Seat support angle 132 may be approximately 15 to approximately 25 degrees, and preferably approximately 18 degrees. In contrast, corresponding seat mounting angles in typical tricycles and bicycles are approximately zero degrees.

Head tube angle 124 and seat support angle 132 may form two corners of an imaginary triangle, with a downward-opening obtuse angle 136 forming the third corner. Angle 136 may be formed between longitudinal axis 128 of the head tube and longitudinal axis 134 of the inclined portion of the frame tube. Angle 136 may be greater than about 110 degrees. In some cases, angle 136 may be greater than about 120 degrees, and in some examples is preferably about 122 degrees.

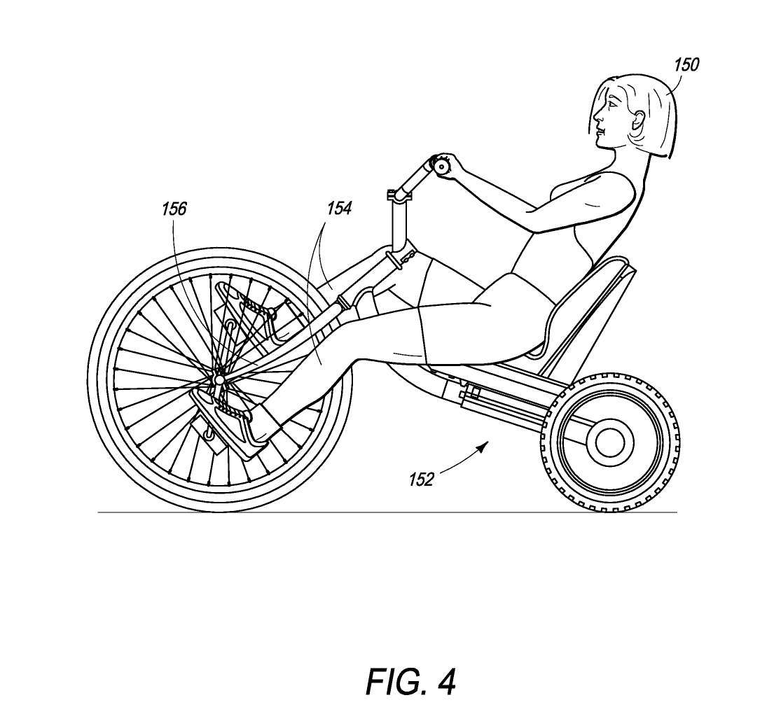

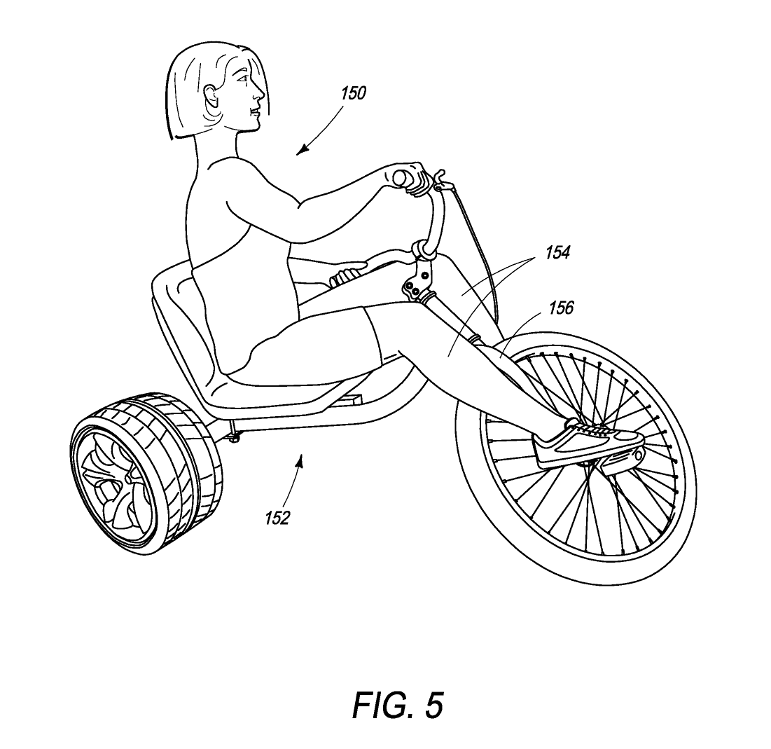

The combination of seat support angle 132 and head tube angle 124 may further facilitate maintaining the rider's legs in line (or within a plane) of fork 100 among a plurality of positions of steering assembly 104 and of pedals 114. This effect is illustrated in FIGS. 4 and 5. FIG. 4 shows an illustrative rider 150 on a tricycle 152 similar to tricycles 10 and 80, with the front wheel unturned and lower legs 154 of rider 150 substantially aligned with a fork 156 of the tricycle. FIG. 5 shows rider 150 on tricycle 152 with the handlebars and front wheel turned, illustrating that the rider's legs 154 are maintained substantially in line with the front fork. Maintaining the rider's legs in line with the fork may reduce the risk that the front wheel contacts the rider's legs while turning, because the legs are close to the axis of rotation, and the wheel turns less from side to side than it would, for example, with a steeper head tube angle, as explained further below.

Turning a wheeled vehicle involves forces including varying amounts of both camber thrust due to the leaning of a wheel, and cornering force due to the steering of the wheel. In other words, a spinning wheel on a support surface will turn as a result of either tilting on an axis parallel to the support surface, rotating on an axis perpendicular to the support surface, or a combination of both tilting and rotating. For example, a bicycle may be turned by simultaneously rotating the handlebars and leaning the bicycle. In a typical tricycle, however, the head angle is very steep, and leaning of the vehicle is constrained by the two rear wheels. Accordingly, steering is accomplished largely through rotation of the front wheel from side to side. This can create stability problems, because when the front wheel is turned, forward momentum of the tricycle will no longer be aligned with the wheel, resulting in a force tending to flip the wheel sideways that cannot typically be compensated for by leaning the wheel and/or reducing the amount of sideways rotation. Additionally, in a typical tricycle and especially in other adult tricycles having a relatively large front wheel and low seat position, a rider's legs may be at a shallower angle than the front forks, thus placing the legs in the path of the wheel as it is steered from side to side, creating a substantial safety risk.

In a tricycle such as tricycles 10, 80, and 152, however, the shallow head tube angle allows the front wheel to both tilt and rotate when the handlebars are turned, thus providing the benefits of a bicycle's turning method. Specifically, turning the handlebars on a tricycle constructed according to the present disclosure causes the front wheel simultaneously to tilt on an axis parallel to the support surface and to rotate side to side on an axis perpendicular to the support surface, thus providing both camber thrust and cornering force, respectively. Accordingly, for the same turn, the front wheel rotates from side to side significantly less than a typical tricycle. Combined with the angle of the legs of the rider, which approximates the angle of the fork, this arrangement provides improved safety and handling characteristics.

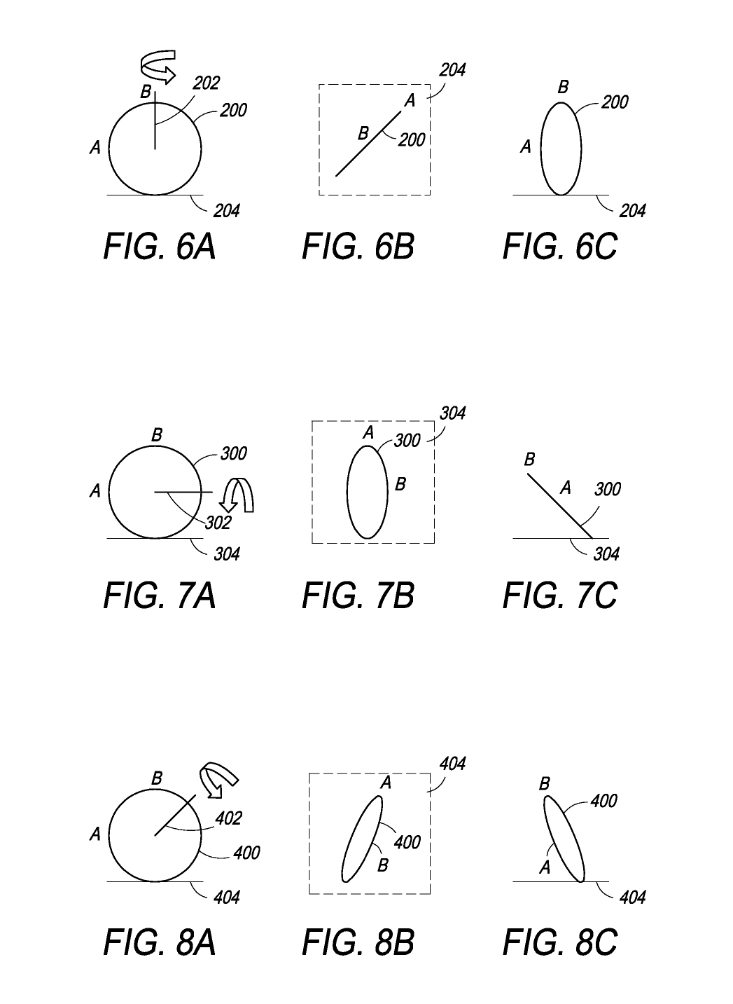

FIGS. 6A through 8C illustrate the previous point. FIG. 6A shows a side view of a front wheel 200 mounted to a fork 202 having a 90 degree angle to a support surface 204 (i.e. fork 200 is vertical). A front portion of wheel 200 is labeled A, and a top portion is labeled B. FIGS. 6B and 6C show an overhead and front view, respectively, of wheel 200 when wheel 200 is turned to the right by rotating on the vertical axis formed by fork 202. All rotation is about an axis perpendicular to support surface 204, and no tilting of the wheel results from rotating fork 202. In other words, turning a vertical fork steers or rotates the wheel side to side only.

FIG. 7A shows a side view of a front wheel 300 mounted to a fork 302 parallel to a support surface 304 (i.e., fork 302 is horizontal). A front portion of wheel 300 is labeled A, and a top portion is labeled B. FIGS. 7B and 7C show an overhead and front view, respectively, of wheel 300 when wheel 300 is turned to the right by rotating on the horizontal axis formed by fork 302. All rotation is about an axis parallel to support surface 304. In other words, turning a horizontal fork tilts the wheel only.

FIG. 8A shows a side view of a front wheel 400 mounted to a fork 402 having a shallow angle with respect to a support surface 404, similar to that created by head angle 124 described above. A front portion of wheel 400 is labeled A, and a top portion is labeled B. FIGS. 8B and 8C show an overhead and front view, respectively, of wheel 400 when wheel 400 is turned to the right by rotating on the axis formed by fork 402. In this example, rotation results about an axis perpendicular to support surface 404 and about an axis parallel to support surface 404. In other words, turning an angled fork both tilts and steers the wheel. Additionally, the same amount of rotation of the fork will result in less rotation on each respective axis than in either of the previous examples.

To help prevent the front wheel from contacting the rider's legs, other adult tricycles may require a relatively small front wheel of about 16 to about 20 inches in diameter, which may result in very low riding speeds. Conversely, a tricycle constructed according to the present disclosure may provide significant safety and performance features, and may allow use of a larger front wheel with a resulting improvement in speed capacity.

Additionally, a low seat position in tricycles such as tricycle 10, 80, and 152 provides a low center of gravity for the vehicle because the rider is located substantially behind the front wheel rather than at an elevation near or above that of the head tube. This adds to the overall stability of the tricycle.

In use, a tricycle constructed according to the present disclosure may provide a stable vehicle capable of controlled drifting, or lateral sliding, of the rear wheels. This may be accomplished, among other possible methods, by turning the front wheel abruptly at speed. The combination of a low center of gravity, front wheel dynamics, and relatively low coefficient of friction of the rear wheels may result in a sliding of the rear wheels across the support surface. Overall, the lowered and angled seat position, shallow head tube angle, and front wheel dynamics combine to make a tricycle such as tricycle 10, 80, and 152 safe and enjoyable.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of those claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure. Where such claims recite “a” or “a first” element or the equivalent thereof, such claims should be understood to include incorporation of one or more such elements, neither requiring nor excluding two or more such elements.

What is claimed is:

1. A three-wheeled, human-powered vehicle comprising
a frame including a frame tube having a first end and a second end, a head tube attached to the frame tube at the first end, and an axle tube attached to the frame tube at the second end;
a fork pivotably attached to the head tube;
a front wheel having a hub rotatably attached to the fork;
a pair of crank shafts attached to the hub of the front wheel, each crank shaft including a foot pedal;
first and second rear wheels rotatably connected proximate opposite ends of the axle tube;
a seat attached to the frame tube proximate the second end of the frame tube; and
a head tube angle defined as an acute angle formed by a longitudinal axis of the head tube with respect to a substantially planar support surface when the front wheel and rear wheels are in contact with the support surface;
wherein lower legs of a rider supported by the seat and having a foot disposed on each of a respective one of the two foot pedals will form a lower leg angle with respect to the support surface, and the lower leg angle approximates the head tube angle.

2. The vehicle of claim 1, wherein the frame tube slopes continuously toward the support surface from the head tube to the axle tube.

3. The vehicle of claim 1, wherein the frame tube has at least one curvilinear portion and at least one linear portion.

4. The vehicle of claim 1, wherein the front wheel is larger than the two rear wheels.

5. The vehicle of claim 1, wherein the head tube angle is approximately 35 to approximately 45 degrees.

6. The vehicle of claim 5, wherein the head tube angle is approximately 40 degrees.

7. The vehicle of claim 1, wherein pivoting of the fork results in lateral tilting of the front wheel.

8. The vehicle of claim 1, wherein the fork is placeable in a plurality of pivoted positions and the front wheel does not contact the lower legs of the rider in any of the plurality of pivoted positions.

9. A three-wheeled human-powered vehicle comprising
a frame including a frame tube having a first end and a second end, a head tube having a first longitudinal axis and connected to the first end of the frame tube, and an axle tube operatively connected to the second end of the frame tube;
a fork assembly rotatably connected to the head tube;
a front wheel rotatably connected to the fork assembly;
a first rear wheel and a second rear wheel, the first and second rear wheels rotatably connected to the axle tube on respective opposite sides of a midpoint of the axle tube;
a seat adjustably connected to a substantially linear inclined portion of the frame tube proximate the second end of the frame tube, the substantially linear inclined portion of the frame tube having a second longitudinal axis; and
a downward-opening obtuse angle being formed between a first line including the first longitudinal axis and a second line including the second longitudinal axis;
wherein the obtuse angle is greater than about 120 degrees.

10. The vehicle of claim 9, wherein when a rider is supported by the seat with a foot on a pedal operatively connected to the front wheel, an upper portion of a leg of the rider is approximately parallel to the second longitudinal axis and a lower portion of the leg of the rider is approximately parallel to the first longitudinal axis.

11. The vehicle of claim 9, wherein the frame tube slopes continuously downward from the first end to the second end.

12. The vehicle of claim 9, wherein the front wheel is larger than the rear wheels.

13. The vehicle of claim 9, wherein the front wheel includes a tire having a first coefficient of friction with respect to a support surface, each of the rear wheels includes an outer surface having a second coefficient of friction with respect to the support surface, and the first coefficient of friction is higher than the second coefficient of friction.

14. The vehicle of claim 9, wherein the obtuse angle is approximately 120 degrees to approximately 130 degrees.

15. The vehicle of claim 9, wherein rotation of the fork assembly results in lateral tilting of the front wheel.

16. A three-wheeled human-powered vehicle comprising
a frame including a frame tube having a first end and a second end, a head tube connected to the first end of the frame tube, and an axle tube operatively connected to the second end of the frame tube;
a fork assembly connected to the head tube such that the fork assembly is rotatable about a longitudinal axis of the head tube;
a front wheel rotatably connected to the fork assembly;
a first rear wheel and a second rear wheel, the first and second rear wheels rotatably connected to the axle tube on respective opposite sides of a midpoint of the axle tube;
a seat adjustably connected to a substantially linear portion of the frame tube proximate the second end of the frame tube, the substantially linear portion of the frame tube having a longitudinal axis;
a head tube angle defined as an acute angle formed by the longitudinal axis of the head tube with respect to a substantially planar support surface when the front wheel and rear wheels are in contact with the support surface
a seat support angle being formed between the substantially planar support surface and the longitudinal axis of the substantially linear portion of the frame tube;
wherein the head tube angle is less than about 45 degrees and the seat support angle is less than about 20 degrees.

17. The vehicle of claim 16, wherein the frame tube slopes continuously toward the support surface from the first end to the second end.

18. The vehicle of claim 16, wherein the front wheel has a diameter larger than a diameter of each of the rear wheels.

19. The vehicle of claim 18, wherein the diameter of the front wheel is greater than approximately 20 inches.

20. The vehicle of claim 16, wherein the head tube angle is approximately 30 degrees to approximately 45 degrees, and the seat support angle is approximately 15 degrees to approximately 20 degrees.

21. The vehicle of claim 20, wherein the head tube angle is approximately 40 degrees and the seat support angle is approximately 18 degrees.

22. The vehicle of claim 16, wherein rotation of the fork results in tilting of the front wheel.

23. A three-wheeled human-powered vehicle comprising
a frame including a frame tube having a first end and a second end, a head tube connected to the first end of the frame tube, and an axle tube operatively connected to the second end of the frame tube;
a fork assembly connected to the head tube such that the fork assembly is rotatable about a longitudinal axis of the head tube, the fork assembly being angled from the first end of the frame tube away from the second end of the frame tube;
a front wheel rotatably connected to the fork assembly;
a first and a second crank arm for imparting rotational motion to the front wheel, the first and second crank arms operatively connected to respective opposite sides of a hub of the front wheel;
a handlebar operatively connected to the fork assembly for rotating the fork assembly about the longitudinal axis of the head tube; and
a first rear wheel and a second rear wheel, the first and second rear wheels rotatably connected to the axle tube on respective opposite sides of a midpoint of the axle tube;
wherein rotating the fork assembly when the front and rear wheels are supported on a support surface causes the front wheel simultaneously to tilt about an axis substantially parallel to the support surface and to rotate about an axis substantially perpendicular to the support surface.

24. The vehicle of claim 23, wherein the fork assembly is angled approximately 30 to approximately 45 degrees from the support surface.

25. The vehicle of claim 23, wherein the second end of the frame tube is closer to the support surface than the first end of the frame tube.

26. The vehicle of claim 23, wherein the front wheel has a diameter larger than a diameter of either of the rear wheels.

27. The vehicle of claim 26, wherein the front wheel has a diameter greater than 20 inches.

28. The vehicle of claim 23, wherein the front wheel includes a tire having a first coefficient of friction with respect to the support surface, each of the rear wheels includes an outer surface having a second coefficient of friction with respect to the support surface, and the first coefficient of friction is higher than the second coefficient of friction.
